(19) United States
(12) Patent Application Publication
(10) Pub. No.: US 2015/0260341 A1
(43) Pub. Date: Sep. 17, 2015

(54) METHODS FOR LIQUEFIED NATURAL GAS DEFUELING

(71) Applicants: Ron C. Lee, Bloomsbury, NJ (US); Andrew P. Richardson, Clinton, NJ (US)

(72) Inventors: Ron C. Lee, Bloomsbury, NJ (US); Andrew P. Richardson, Clinton, NJ (US)

(21) Appl. No.: 14/215,198

(22) Filed: Mar. 17, 2014

(51) Int. Cl. F17C 7/04

(52) U.S. Cl. CPC F17C 7/04

(57) ABSTRACT

A method of steps for decanting a cryogenic fluid from a storage tank that is in fluid communication with a back pressure regulator and a decant dewar. A minimum pressure is set for the back pressure regulator and a cryogenic fluid is fed from the storage tank to the back pressure regulator. When the pressure of the cryogenic fluid exceeds the minimum pressure set for the back pressure regulator, the cryogenic fluid is fed to the decant dewar. This flow will continue until the storage tank is essentially empty. The gas generated by this depressurization will be fed to an exit valve where it can be flared or recovered by the operator for additional uses.

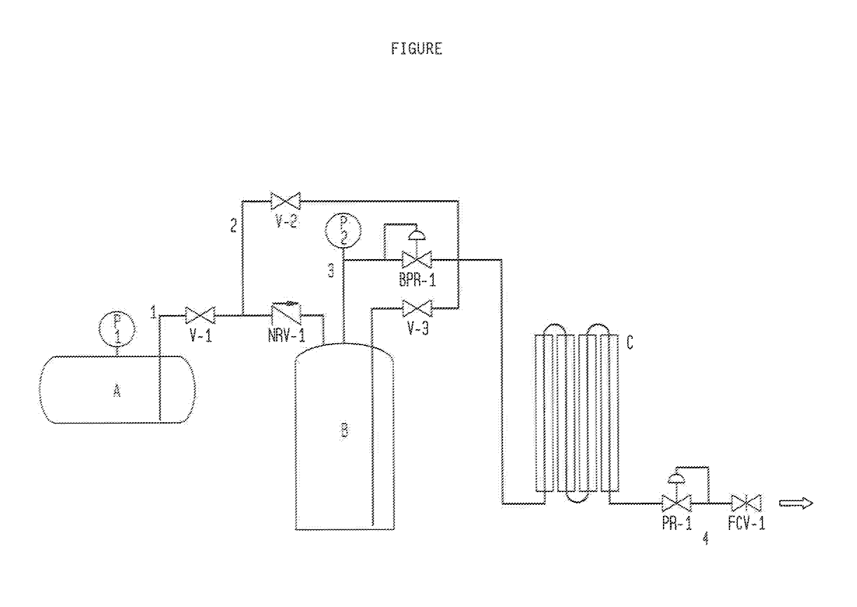

### BACKGROUND OF THE INVENTION

Liquefied natural gas (LNG) fuelled vehicles and trucks must have the LNG periodically removed from theft onboard storage tanks. While direct venting to the atmosphere is possible, it is generally not an environmentally acceptable practice. The LNG can also be recovered through a process of decanting and transfer of the contents to another cryogenic container. Decanting will typically also require a significant amount of venting to the atmosphere which is particularly true when the decant container is not already at cryogenic temperature. The LNG and/or vapor that can be directly transferred into a bulk LNG storage container but this will require the availability of a bulk LNG storage container equipped to receive large quantities of LNG rather than only vapor. While some limited vapor recovery is a standard feature in many LNG fuelling stations, larger quantities of liquid recovery is not. The LNG can also be removed and routed to a flare/burner for disposal. However, a flare sized to remove the fuel contents of an onboard storage container in a reasonable time frame is quite large and expensive, and not possible in all fueling locations.

The present invention attempts to avoid these problems and efficiently dispose of LNG without any direct venting to the atmosphere. This method will provide for rapid defueling from storage tanks while minimizing the size of the burner/flare technology necessary. The method can be employed regardless of the availability of bulk cryogenic storage containers or fuelling station.

### SUMMARY OF THE INVENTION

In one embodiment of the invention, there is disclosed a method for decanting a cryogenic fluid from a storage tank comprising the steps:
a) Feeding the cryogenic fluid from the storage tank to a decant dewar, thereby generating gas produced by depressurization and warming of the cryogenic fluid;
b) Feeding the gas generated in step a) to an exit valve; and
c) Feeding the generated gas to a flare wherein the generated gas is combusted.

A minimum pressure value can be set for the back pressure regulator in fluid communication with a decant dewar.

The gas is fed to the exit valve when the pressure of the gas exceeds a minimum pressure value for the decant dewar.

The cryogenic fluid that is typically decanted is a fuel such as liquefied natural gas. Other flammable cryogenic liquids may also be employed as the fuel.

The gas that is fed to the flare is typically fed at a constant flow ate.

The decanting can be done periodically or in a continuous basis depending upon the configuration of the storage tank and the decant dewar. For example, there can be a plurality of storage tanks and/or decant dewars which the decant process of the invention could be performed on. A typical decant of a storage tank can occur in less than two hours. The decant dewar can be sized to accommodate multiple decants from storage tanks.

The minimum pressure for the back pressure regulator is adjustable by the operator of the decanting method. This pressure can act as a throttle in the sense that the operator can control at what point the cryogenic liquid flows from the storage tank to the decant dewar. The minimum pressure for the back pressure regulator is typically about 3 to 4 barg.

A vaporizer may also be in fluid communication with the back pressure regulator such that the flow of cryogenic fluid through the backpressure regulator is fully vaporized to the gas form of the cryogenic fluid so that it readily passes through the exit valve and can be flared immediately or forwarded to additional uses the operator may desire.

The storage tank can be a fixed storage tank or it can be the storage tank on a moving vehicle that is fueled by liquefied natural gas.

Liquid nitrogen may also be employed to supplement the decant process. For example, by precooling the decant dewar or re-condensing a portion of the cryogenic gas vapor produced.

In another embodiment of the invention there is disclosed a method of flaring a cryogenic fluid comprising the steps:
a) Feeding the cryogenic fluid from a storage tank to a decant dewar thereby generating gas produced by depressurization and warming of the cryogenic fluid;
b) Setting a minimum pressure value for a back pressure regulator in fluid communication with the decant dewar; and
c) Feeding the cryogenic gas from the decant dewar to a flare when the pressure of the cryogenic gas exceeds the minimum pressure value for the back pressure regulator.

### BRIEF DESCRIPTION OF THE DRAWINGS

The FIGURE is a schematic representation of a liquefied natural gas defueling system as per the invention.

### DETAILED DESCRIPTION OF THE INVENTION

Turning to the FIGURE, a schematic representation of a cryogenic flammable liquid defueling system is shown. The cryogenic flammable liquid is exemplified in the schematic as liquefied natural gas.

The liquefied natural gas storage tank A will typically be at least partially filled with LNG and typically be at a pressure P1 greater than about 5 barg, up to a maximum of about 12 barg. The liquefied natural gas storage tank A may be a single tank onboard of a truck or it may be two or more tanks coupled together. Typically the total volume of the tank or tanks is about 400 to 800 liters.

The decant dewar B will be typically empty or nearly empty. The decant dewar B will be warm or cold and at a pressure P2 that ranges from ambient to about 12 barg.

BPR-1 is a back pressure regulator that will typically be set at a pressure of about 3 to 4 barg. PR-1 is a pressure regulator and FCV-1 which is selected from the group of controllers selected from a needle valve and a flow control orifice will work in conjunction to supply a constant flow of natural gas to the flare through line 4. This flow of natural gas will be the combination of flash gas and boil-off gas that is generated during the decant operation and will typically be such that a full decant can occur within about 1 to 2 hours. The flow must also be sized to completely empty the decant dewar B once it is filled within about 12 to 24 hours.

The liquefied natural gas storage tank A is connected to the decant dewar B through line 1. Liquefied natural gas will flow through open valve V-1 and check valve or non-return valve NRV-1. The flare not shown may be started provided that there is sufficient pressure in the decant dewar B or the flare may be started after the decant dewar B pressurizes during the decant. Valves V-2 and V-3 are dosed and valve V-1 is opened. Liquefied natural gas will begin flowing from the liquefied natural gas storage tank A through line 1 to decant dewar B. This will produce some flash gas which is the natural gas vapor produced by depressurization of saturated liquefied natural gas and typically some boil-off gas as the decant dewar and piping is cooled.

The pressure P-2 of the decant dewar B will typically rise above the setting of the back pressure regulator BPR-1 due to the limited flow of natural gas that can be handled by the flare. This aspect of the system operation is self limiting and will require no user intervention. As the decant dewar B cools and the decant process progresses, the pressure P-2 will typically drop but will not drop below the setting of the back pressure regulator valve BPR-1 which is typically on the order of 3 to 4 barg. This pressure limiting behavior of the back pressure regulator valve BPR-1 will limit the amount of flash gas that will be generated by the decant operation and progress the overall decant operation as rapidly as possible.

When all of the liquefied natural gas in the liquefied natural gas storage tank A has been transferred to the decant dewar B, both the liquefied natural gas storage tank A and the decant dewar B will approach the pressure setting determined by the back pressure regulation valve BPR-1. When this occurs, the decant operation is complete but there is residual pressure in the liquefied natural gas storage tank A which can optionally be depressurized by opening valve V-2. This step will depressurize the liquefied natural gas storage tank A to approximately the pressure of the pressure setting for valve PR-1, without causing depressurization of the decant dewar B because of the non-return valve NRV-1.

When the liquefied natural gas storage tank A has been fully decanted and optionally depressurized, valves V-1 and V-2 may now be closed and the liquefied natural gas storage tank A disconnected from the decant dewar B. Valve V-3 may now be opened which will feed liquid natural gas to the vaporizer C through line 2 to line 3 at a fixed flow determined by the flare flow control elements PR-1 and FCV-1. This flow will continue until the liquefied natural gas has been fully removed from the decant dewar B.

Additional control valves and devices such as isolation valves between the liquefied natural gas storage tank A, decant dewar B and the flare through line 4 may be included in the design of the inventive system. Further a pressure building circuit may also be made on the decant dewar B.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what we claim is:

1. A method for decanting a cryogenic fluid from a storage tank comprising the steps:
a) Feeding the cryogenic fluid from the storage tank to a decant dewar, thereby generating gas produced by depressurization and warming of the cryogenic fluid;
b) Feeding the gas generated in step a) to an exit valve; and
c) Feeding the generated gas to a flare wherein the generated gas is combusted.

2. The method as claimed in claim 1 wherein a minimum pressure value of the decant dewar is set by a back pressure regulator in fluid communication with the decant dewar and exit valve.

3. The method as claimed in claim 1 wherein the gas is fed to the exit valve when the pressure of the gas exceeds a minimum pressure value for the decant dewar.

4. The method as claimed in claim 1 wherein the decanting is periodic.

5. The method as claimed in claim 1 wherein the cryogenic fluid is liquefied natural gas.

6. The method as claimed in claim 2 wherein the minimum pressure is about 3 to 4 barg.

7. The method as claimed in claim 1 wherein the cryogenic fluid is continually fed until the storage tank is essentially empty.

8. The method as claimed in claim 1 wherein the cryogenic fluid remaining in the decant dewar after decanting from the storage tank is fed to the flare.

9. The method as claimed in claim 1 further comprising a vaporizer in fluid communication with the exit valve.

10. The method as claimed in claim 1 where the cryogenic gas fed to the flare is fed at a constant flow rate.

11. The method as claimed in claim 1 wherein a full decant will occur in less than 2 hours.

12. The method as claimed in claim 1 wherein the storage tank is on a vehicle.

13. The method as claimed in claim 1 wherein the storage tank is more than one storage tank.

14. The method as claimed in claim 1 wherein the decant dewar is more than one decant dewar.

15. A method of flaring a cryogenic fluid comprising the steps:
a) Feeding the cryogenic fluid from a storage tank to a decant dewar thereby generating gas produced by depressurization and warming of the cryogenic fluid;
b) Setting a minimum pressure value for a back pressure regulator in fluid communication with the decant dewar; and
c) Feeding the gas from the decant dewar to a flare when the pressure of the gas exceeds the minimum pressure value for the back pressure regulator.

16. The method as claimed in claim 15 wherein the flaring is periodic.

17. The method as claimed in claim 15 wherein the cryogenic fluid is liquefied natural gas.

18. The method as claimed in claim 15 wherein the minimum pressure for the back pressure regulator is about 3 to 4 barg.

19. The method as clamed in claim 15 wherein the gas fed to the flare is combusted.

20. The method as claimed in claim 15 further comprising a vaporizer in fluid communication with the back pressure regulator.

21. The method as claimed in claim 15 where the cryogenic gas fed to the flare is fed at a constant flow rate.

22. The method as claimed in claim 15 wherein the storage tank is on a vehicle.

23. The method as claimed in claim 15 wherein the storage tank is more than one storage tank.

24. The method as claimed in claim 15 wherein the decant dewar is more than one decant dewar.
